(19) United States
(12) Patent Application Publication
(10) Pub. No.: US 2010/0297290 A1
(43) Pub. Date: Nov. 25, 2010

(54) ALTERNATIVE METHOD FOR RUM PRODUCTION REDUCING POLLUTION AND BYPASSING UPGRADE OF POLLUTION CONTROLS

(76) Inventors: John LaRue, (US); Paul Fahrenthold, (US)

Correspondence Address: GROOVER & Associates, BOX 802889, DALLAS, TX, 75380-2889, US

(21) Appl. No.: 12/624,868

(22) Filed: Nov. 24, 2009

Related U.S. Application Data
(60) Provisional application No. 61/181,971, filed on May 28, 2009.

(51) Int. Cl. C12C 11/00; C12H 1/00; C12C 12/00

(52) U.S. Cl. 426/14; 426/397; 426/422

(57) ABSTRACT

A method and process for producing a high quality, high-end ethanol product from a lower quality, low-end ethanol product. The method and process can eliminate or reduce waste disposal costs for a distillery constrained by its location from employing an acceptable, cost-effective waste disposal method.

### CROSS REFERENCE TO RELATED APPLICATIONS

This application claims priority from provisional patent application 61/181,971, filed on May 28, 2009, which is hereby incorporated by reference.

### BACKGROUND

The present application relates to distilling rum, and more particularly to a distilling method that reduces pollution without upgrading pollution controls.

In a typical rum distillery, the distiller produces a beverage grade ethanol by fermenting molasses, stripping the ethanol from the fermented molasses (called “beer” in some applications) and purifying the crude ethanol by further distilling to produce rum. Rum production is notorious for pollution, and these problems are not easily solved. As the raw molasses is produced, fermented, and distilled, a high salt residue accumulates that must be disposed. The mostos stream (rum slops or vinasse in Spanish) produced from the main still, or the alcohol stripping column, contains 95% of the pollution. The mostos stream effluent typically contains high levels of toxic pollutants (lead, iron, zinc, etc) and organic byproducts such as sugar, organic acids, amino acids, proteins, polysaccharides, lignins, and inorganic salt complexes, as well as fusel oils. This stream contains significant quantities of oxygen demanding contaminants that are deleterious for receiving waters.

Traditionally, disposal of this waste often involved discharge into a water source, such as a creek, river, or the ocean. Ocean and other water discharge can lead to a pollution plume of hazardous or noxious waste. More environmental acceptable methods employ pre-treatment of the waste stream prior to discharge. Other disposal methods include spraying on dusty unpaved roads to reduce dust, cattle feed, farming, land farming, and some use as fuel or a fuel additive. However, these other options may be unavailable in a given geographic location, such as an island. Most rum production occurs on islands in the West Indies, with concurrent restraints on available disposal methods. FIG. 1 show a satellite photograph of a pollution plume associated with a Caribbean island distillery; the Cruzan distillery in St. Croix. The photograph shows the Cruzan distillery, a discharge line, and the pollution plume caused by discharged by-products.

In the United States, the Environmental Protection Agency (EPA) has increasingly focused enforcement efforts on rum distillery discharges. The EPA has been attempting to force one exemplary rum distillery for 15 years to clean up or shut down. However, a treatment plant for the waste would require construction of an estimated $20 million treatment plant, and the production of rum is not profitable enough to justify a $20 million treatment plant. Further, there is a concern that the present treatment technology may not work since it has not been applied in rum production facilities.

Present-day technology may not be able to provide a satisfactory solution for processing of rum distillation residues. Furnace treatment of residues is ineffective. The residue contains a large fraction of sodium and potassium salts. When these residues are heated up to typical combustion temperatures, the sodium and potassium salts melt into a viscous ash, which will not pour. Laboratory tests show that that the melted ash will not flow even when heated to 1950° F. Thus, any thermal oxidation processes risks an accretion of scale on the furnace, which must eventually be removed manually. Such a process is impractical for commercial use.

### SUMMARY

The present application discloses new approaches to producing rum and avoiding the production of residual waste.

In some embodiments, the inventions include a novel approach to producing rum by importing a low quality ethanol feedstock produced from sugarcane. The feedstock is distilled to produce higher quality rum.

The disclosed innovations, in various embodiments, provide one or more of at least the following advantages. However, not all of these advantages result from every one of the innovations disclosed, and this list of advantages does not limit the various claimed inventions.
Lower costs compared to constructing waste treatment facilities.
Less to no pollution produced in the rum production at an exiting distillery.
Less energy use.
More economical and environmentally safe disposal of waste products at another location.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The disclosed inventions will be described with reference to the accompanying drawings, which show important sample embodiments of the invention and which are incorporated in the specification hereof by reference, wherein:

FIG. 1 shows a color satellite photograph of an exemplary distillery and pollution plume.

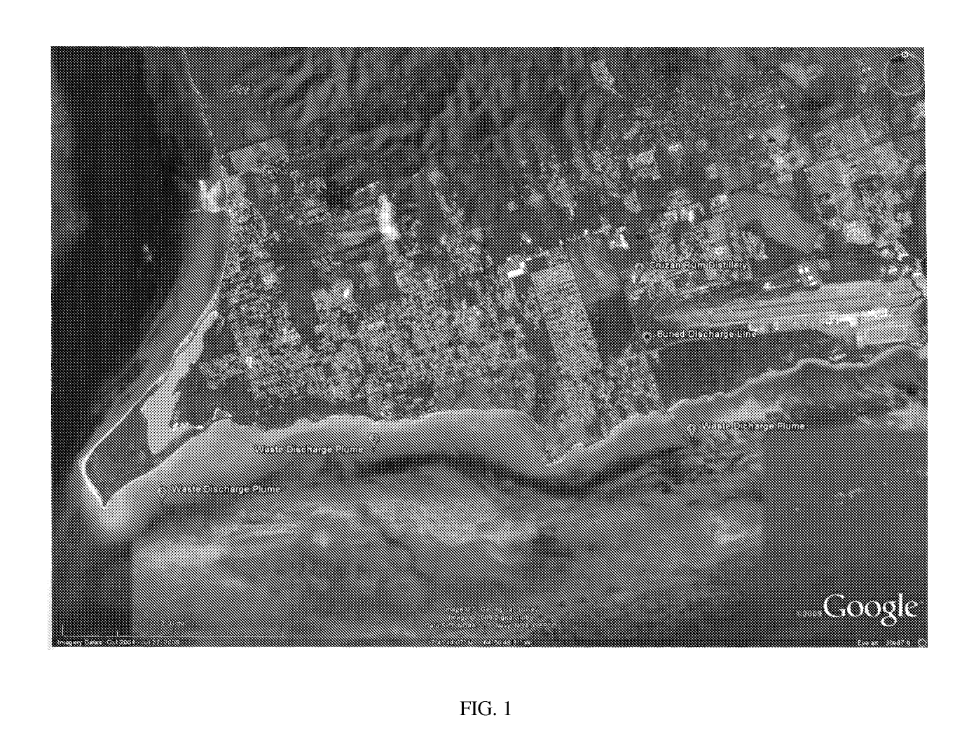

FIG. 2 shows a simple pot still suitable for initial distillation to obtain a crude ethanol feed stock.

FIG. 3 shows a schematic example of a four-column distillation and rectification system for rum production.

FIG. 4 shows a process flow for the production of rum using the inventions.

### DETAILED DESCRIPTION OF SAMPLE EMBODIMENTS

The numerous innovative teachings of the present application will be described with particular reference to presently preferred embodiments (by way of example, and not of limitation). The present application describes several inventions, and none of the statements below should be taken as limiting the claims generally.

The inventions include a novel rum producing process and business method by importing a low quality distilled rum feedstock produced from sugarcane or molasses, with the feedstock distilled yet again to produce higher quality rum. The double distillation process occurs at geographically separate distilleries, with an initial distillation of beer followed by a subsequent distillation/rectification. This double distillation method preserves the flavor components of the original distillation method, so the end product both tastes like rum and legally is rum.

The US Bureau of Alcohol, Tobacco and Firearms regulations (1982) define rum as an alcoholic distillate produced from fermented juice of sugarcane, sugarcane syrup, sugarcane molasses, or other sugarcane by-products. The produced beverage contains less than 190° proof (95° GL) and is produced in such a manner that the distillate possesses the taste, aroma, and characteristics generally attributed to rum. The bottled rum contains not less than 80° proof (40° GL), and also includes mixtures solely of such distillates. Unlike the regulations for whisky, the rum does not require ageing in oak barrels for a minimum period of time. Further, unlike some countries, the US regulations also do not require production in any particular geographic region.

By definition, rum is produced directly or indirectly from sugarcane, and can include the use of molasses. One exemplary rum distillery uses molasses purchased from various sources. The alcohol industry typically makes ethanol from corn or a sugar source, such as citrus, which is fermented, but only ethanol made from sugarcane fits the definition of rum. Ethanol made from corn, for example, is not rum.

The basic approach of the inventions is to use a low grade ethanol feedstock produced at another location, such as Brazil, which can use the residue for other purposes (e.g., fuel, cattle feed, feed supplements, irrigation, etc.), and can often be done on small farms or by local distillers. For example, Cachaça is a low quality ethanol produced from sugarcane juice in Brazil, where 1.5 billion liters (396 million gallons) are consumed annually (roughly eight liters per head). A distillery can eliminate the fermentation of molasses at the distillery and immediately solve the pollution problem using such a low quality ethanol feedstock. An exemplary distiller can import a crude ethanol stream from a distillery outside US authority that ferments sugarcane or a sugarcane product (e.g., molasses), which by definition is still rum. The importing distillery distills the imported crude ethanol to produce a finished higher quality rum identical to rum produced by fermenting and distilling molasses. The crude rum feedstock is less expensive than molasses and permits a distillery to virtually eliminate objectionable waste discharge.

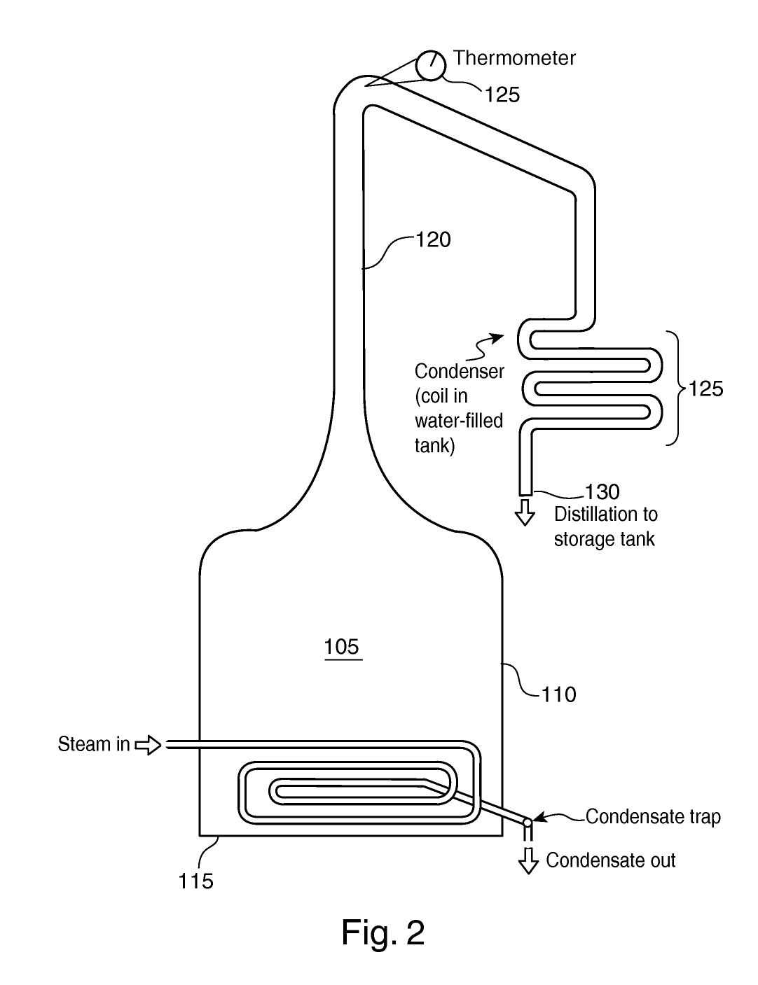

FIG. 2 shows a simple pot still suitable for initial distillation to obtain a crude ethanol feed stock. It is contemplated that a pot still or single column distillation system can produce an acceptable feedstock. A two-column distillation process may also be used, but is not required. Fermented beer feedstock 105 in the pot still 110 is heated with an internal steam coil (calandria) or alternatively with a wood fire or bagasse underneath. A vapor pipe 120 fitted to the pot still 110 collects distilled ethanol and other volatile congeners from the beer feedstock 105. A thermometer 125 monitors the distillate temperature and provides a rough guide as to the content and makeup of the distillate.

Distillate is collected as different “heads,” or fractions, and passes into a condenser coil 130, typically submerged in a water-filled tank. The distillate flows from an outlet 135 into a storage tank. The first fraction distilled usually contains a higher portion of the higher volatile, pungent congeners (e.g., aldehydes, organic acids, esters, and fusel oils), with this “heads cut” discarded. The “center cut” contains the bulk of the ethanol and non-ethanol byproducts desired for flavoring. The “tails cut” at the end of the distillation is also discarded.

Distillers typically discard the beer residue, or “stillage”, which makes up a substantial portion of waste residue left in the still pot 110. The “head cut” and “tails cut” can be discarded or redistilled with a second discarded “head cut” and “tails cut”, but this may be unnecessary to provide an acceptable ethanol feedstock.

An experimental distillation was carried out to determine if Cachaça, a low-grade Brazilian Rum, can be distilled to the standard of a Bacardi or Cruzan premium rum product.

Purpose: The purpose of the distillation was to remove as many of the low and high boiling compounds found in the overheads from the fermenter product stripper (referred to as beer in some facilities) and produce ethanol of a quality (low concentration of impurities) equal to that of commercial rums found in the domestic US market.

Background: Rum is the alcoholic beverage produced from the fermentation and distillation of sugarcane products. Rum can be made from the juice derived from crushed cane as well as from molasses, either high test or regular molasses.

The alcoholic beverage is obtained from the distillation of the fermented juice or molasses (after dilution) by “stripping” the alcohol from the fermenter broth. The stripped alcohol is accompanied by a large quantity of water in order to insure that all of the alcohol is removed from the broth. The combined water and alcohol stream from the stripper is about 60-70% ethanol.

Fermentation of sugar cane products also produces a number of compounds besides the major product, ethanol. These “impurities” in the stripper overheads give rum a characteristic taste although certain of them are potentially toxic, i.e. methanol, while others can cause adverse side effects, “hangover”, if not removed from the finished product.

Cachaça is the name given to a rum product produced in Brazil from cane juice. Its quality can vary from good to poor, depending upon the characteristics of the distillery. A poor quality Cachaça would be produced by limited purification (called “rectification”) to remove the impurities produced in fermentation.

Examination of the Cachaças sold in the domestic US market indicates that additional rectification is required to meet the quality of most currently available rums. It represents a first-run alcohol distilled from fermented sugarcane and cut with water to 40% ethanol. It is most closely related to moonshine, but as a sugarcane derived ethanol rather than corn derived, it is by definition a rum. This crude rum product primarily differs from high grade rums by containing various fusel oil and related organic compounds not found in a rectified high-quality bottled rum. The current experiment was designed to verify that additional rectification will convert existing Cachaça to a higher quality rum.

Experimental Equipment: Rectification of a commercial Cachaça (Frisco Fish) was carried out in a packed distillation column with condenser and reflux splitter. The equipment used was as follows:
1. Column: The column consisted of four sections of glass tube filled with metallic packing (Ace Glass #6624). The bottom section of the column (the stripping section) was 2 inches diameter and approximately 24 inches long with 55/50 tapered glass joints, male on the bottom and female on the top. The second section from the bottom was a feed section with a 55/50 tapered glass joint on the bottom and a 45/50 glass joint on the top. This section contained no packing. This section was not used as a feed section and was essentially an open or blank section of the column. The third section of the column was a 1.5 inch diameter glass tube filled with the same packing material as the lower section and approximately 18 inches long. The joints were made from 45/50 tapered glass, male on the bottom and female on the top. The fourth section of the column was a short glass tube, perhaps 4 inches long, with a male 45/50 tapered glass joint on the bottom and a 24/40 tapered glass joint on the top. This section was also filled with the same packing material and the first and third sections.
2. Batch Distillation Flask: The material to be distilled was placed in a 5 Liter, 4 neck boiling flask. The center fitting was a 55/50 tapered glass joint that connects to the bottom joint of the lower column section. The other three connections were 24/40 tapered glass joints to allow for thermometers and other monitoring devices.
3. Heating Mantle: The boiling flask was heated with a heating mantle powered with a powerstat. The powerstat was connected to a 110 v outlet.
4. Condenser and Reflux System: The condenser was a glass dip tube with tap water entering the dip tube and the alcohol being vaporized from the column condensing on the surface of an outer glass tube. The condensed vapors returned to the column with a portion of them allowed to exit the column by means of an exit tube. The quantity of condensate returned to the column divided by the quantity removed from the column is called the reflux ratio. That ration could be adjusted by a valve installed in the exit tube.

System Operation: 1500 ml of Cachaça was added to the boiling flask with a boiling stone. Heat was applied at a rate of approximately 60% allowable power, and water started flowing through the glass dip tube in the condenser. Some time was required for the hot vapors to travel from the boiling flask to the condenser. When reflux is observed to occur in the condenser, the ratio of column return to product removed can be established.

Sampling Strategy: The sampling strategy used for this experiment was to remove approximately 300 ml of ethanol as the azeotrope with water and take a small sample after that quantity had been removed. This strategy insured that most of the light ends (those compounds boiling lower than ethanol) had been removed and that most of the higher boiling materials were still in the boiling flask as a result of the high reflux ratio.

Analysis: The sample ethanol was tested to determine the content of impurities remaining after rectification. Final product was as high as 99.99% ethanol with 0.01% 1,1-diethoxyethane, and the rectified product was an acceptable high quality ethanol suitable for ageing and further blending to produce a high end, high quality rum. Additionally, a human taste and smell test was performed using a middle cut from the rectified ethanol. The ethanol's taste and smell was identical to a fine, light rum. Light rum is considered a high quality rum more challenging to produce than a dark rum, so a dark rum can easily be produced using this method.

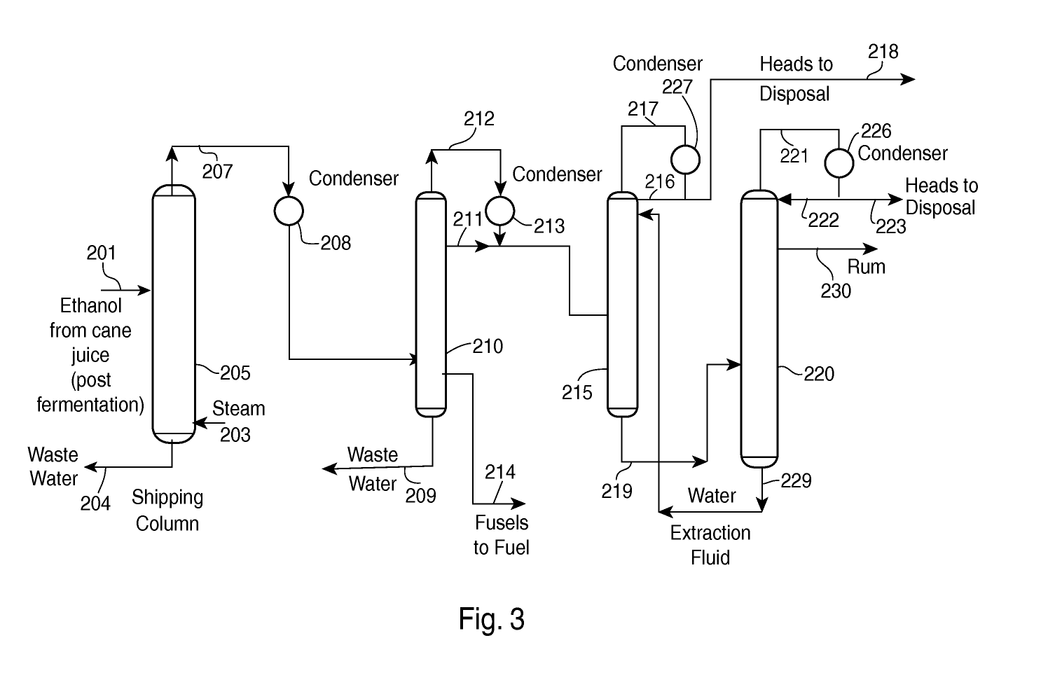

FIG. 3 shows a schematic example of a four-column distillation and rectification system for rum production. In this exemplary system, an ethanol from cane juice (post fermentation) is fed into the first column 205, which in prior art implementations can be referred to as the “beer stripper” or “stripping column”. Steam heat 203 is applied to produce a distillate flowing through a vapor pipe 207 to a condenser 208 and to a second column 210. The waste water 204 is removed for eventual processing and disposal, though it is contemplated that a high fusel oil by-product may be produced at this step suitable for further processing and fuel use.

At the second column 210, which in prior art implementations can be referred to as the “concentrator”, where the distillate is further distilled. There is a waste water stream 209 removed and disposed, and a fraction removed from near the bottom of the column of fusel oils and/or propanol. The high ethanol distillate flows through the vapor pipes 211 and 212, with vapor pipe 211 collecting the more volatile components. Vapor pipe 212 leads to condenser 213 and then to the third column 215, while vapor pipe 212 leads to the condenser output and then to the third column 215.

The third column, which in prior art implementations can be referred to as the “extractive distillation column”, for another distillation step. The volatile non-ethanol components vaporize and exit from vapor pipe 216 and 217, with the vapor pipe 216 going direct to a disposal outlet 218 and the vapor pipe 217 leading to a condenser 227 before the outlet 218. These volatile heads are disposed. A feed outlet 219 flows into the fourth column 220 for a further rectification step, where the column in prior art implementations can be referred to as the “rectifier”. A water and extraction fluid flow 229 from the lower portion of the column 220 flows back into the upper portion of column 215. Rum ethanol comes from outlet 230 at the upper portion of the column 220 capturing a center cut with a high grade rum product.

The four-column distillation and rectification system is exemplary only. Depending on the type or brand of rum, one or more distillation step may be omitted. A four column process as depicted is typically used to produce a light rum, while a darker, more flavorful rum may need only one additional distillation step from the initial crude distillation to produce the desired rum product. However, it is contemplated that a multi-column distillation system will be used for the second distillation, such a two-column, three-column, or four-column process, adjusted and modified as required to obtain a properly rectified ethanol distillate. Fewer columns leaves more of the heavier components of fermentation in the body of the rum, so that the taste has flavors of molasses, etc., due to the presence of various impurities remaining in the distillate with the ethanol. The light rums are produced from more columns and are “purer” in the sense that they have fewer of the heavies, while dark rum contains more of the heavies. Of course, the exemplary Cachaça noted above contains higher proportions of the heavies compared to either light or dark rum.

Rums also depend generally on ageing, and ageing generally produces a darker product compared to a non-aged product depending upon the method. Heavily charred barrels produce a darker product as does a longer age cycle. Light rums can be aged for a shorter time, not at all, or in steel tanks (more like “rested” than aged). There are as many ways to do this as there are types of rum.

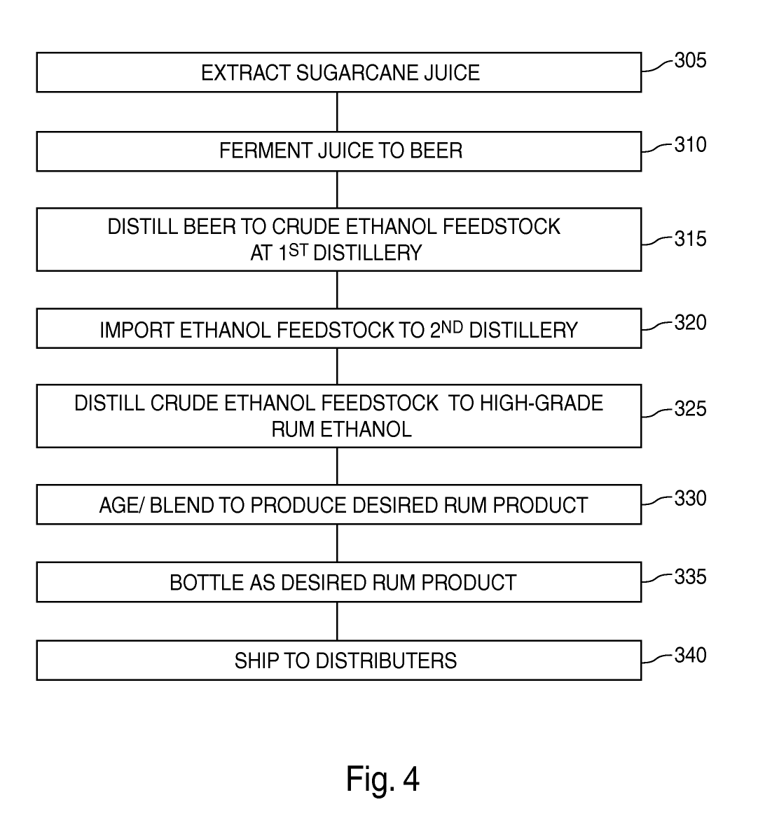

FIG. 4 shows a process flow for the inventions. In step 305, a distiller or supplier extracts sugarcane juice. In step 310, the juice is fermented into an ethanol feedstock referred to as a beer. Alternatively, molasses, syrup, or other sugar cane by-products can be used to produce the beer. Either the juice or molasses can also be trucked from small sugar mills, or it may even come direct from sugarcane farms. The fermented beer likewise can be trucked from a small sugar mill or farm. A distiller can then distill the beer into a crude ethanol feedstock in step 315. This step occurs at the first distiller, and the steps of extracting and fermenting juice, molasses, syrup, or other sugar cane by-products and the initial distillation step produces approximately 95% of the pollution waste stream in rum production. In Brazil, this waste stream can be disposed by use in fuel production, cattle and farming operations, and land farming. Other disposal methods may be available, including water discharge. Alternatively, the distillation can be performed at other than a distillery, such as at a farm or local communal still.

At step 320, a second distillery imports the crude ethanol feedstock. Economically, this feedstock (either from juice or molasses) usually costs less than a traditional molasses that would still require fermentation before use. After importation, the second distillery distills the crude ethanol feedstock to a refined high-grade rum ethanol distillate, containing various desired flavoring non-ethanol products to give it the desired flavor of its sugarcane origins in step 325.

In step 330, this rum ethanol is aged or blended as required to produce the desired rum product. This can require ageing in wood casks and/or blending with spices and other flavoring compounds. In step 335, the rum product is bottled as desired, and in step 340 the rum product is shipped to distributors for wholesale and retail sales. The rum labeling can accurately reflect rum originating at the second distillery.

The foregoing has described a method and process for producing a high quality rum beverage from a lower quality ethanol rum product that are given for illustration and not for limitation and uses. Thus, the inventions are limited only by the appended claims. Although the inventions have been described in accordance with the embodiments shown, one of ordinary skill in the art will readily recognize that there could be variations to the embodiments and those variations would be within the spirit and scope of the present inventions. Accordingly, many modifications may be made by one of ordinary skill in the art without departing from the spirit and scope of the appended claims.

According to various embodiments, there is provided: A process for making rum, comprising the actions of: fermenting sugarcane juice to produce a crude beer feedstock; distilling said crude beer feedstock, at a first distillery, to produce a crude ethanol feedstock distillate, as well as waste byproducts; shipping said crude ethanol feedstock distillate, but not said waste byproducts, to a second distillery which is remote from said first distillery; distilling said crude distillate in said second distillery, to produce a refined beverage liquor which includes flavor components corresponding to sugarcane origins, but which contains fewer non-ethanol alcohols than said crude ethanol distillate; and shipping said refined beverage liquor as rum product which has been distilled in said second distillery.

According to various embodiments, there is provided: A manufacturing process for making rum, comprising the actions of: distilling a crude beer feedstock fermented from a sugarcane extract to produce a low-quality ethanol distillate; shipping the low-quality ethanol distillate to a geographically separate distillery; distilling said low-quality ethanol distillate in the distillery to produce a rectified beverage ethanol that includes flavor components corresponding to sugarcane origins, but which contains fewer non-ethanol alcohols than the said low-quality ethanol distillate; and bottling the rectified beverage ethanol as rum product labeled as distilled in said distillery.

According to various embodiments, there is provided: A method for producing a high-grade ethanol beverage by converting a low-grade ethanol feedstock, comprising the steps of: importing a low-grade ethanol feedstock comprising a crude ethanol distillate containing undesired non-ethanol components; distilling the low-grade ethanol feedstock into a high-grade ethanol at an importing distillery that substantially removes the undesired non-ethanol components; and ageing or blending, or a combination of both, to produce a desired ethanol beverage product flavored so as to be consistent with origin.

According to various embodiments, there is provided: A method for producing a high-grade ethanol beverage, comprising the steps of: extracting an ethanol source for fermenting into a beer for distillation; distilling the beer into a low-grade ethanol feedstock distillate for export to a distillery for refinement into a high-grade ethanol that substantially removes undesired non-ethanol components; wherein extracting, fermenting, and distilling the beer substantially reduces production of waste byproducts at said distillery.

According to various embodiments, there is provided: A method for producing a high-quality ethanol beverage from a low-quality ethanol product, comprising the steps of: a) fermenting an ethanol source and distilling a low-quality ethanol product that contains undesired non-ethanol byproducts; b) exporting the low-grade ethanol feedstock distillate to a distillery for refinement into a high-grade ethanol that substantially removes undesired non-ethanol components and avoids distillery disposal of a substantial portion of the waste byproducts; wherein step a) produces the substantial portion of the waste byproducts in the production of the high-grade ethanol.

According to various embodiments, there is provided: A method for distilling a higher-quality ethanol beverage using a low-quality intermediate ethanol feedstock, comprising the steps of: distilling an imported low-quality ethanol feedstock, wherein the low-quality ethanol feedstock contains undesired non-ethanol components, into a high-quality ethanol at an importing distillery that substantially removes the undesired non-ethanol components; and bottling a desired higher-quality ethanol beverage product aged, flavored, and labeled so as to be consistent with origin, type, and brand of beverage product.

According to various embodiments, there is provided: A business method for manufacturing rum, comprising the actions of: importing crude sugarcane-derived distillate to an established distillery in a location which is subject to difficult environmental waste disposal constraints; distilling said crude distillate in said established distillery to produce a refined beverage liquor which includes flavor components corresponding to sugarcane origins, but which contains fewer non-ethanol alcohols than said crude distillate; and shipping said refined beverage liquor with an accurate representation that is it rum and has been distilled in said established distillery.

### MODIFICATIONS AND VARIATIONS

As will be recognized by those skilled in the art, the innovative concepts described in the present application can be modified and varied over a tremendous range of applications, and accordingly the scope of patented subject matter is not limited by any of the specific exemplary teachings given. It is intended to embrace all such alternatives, modifications and variations that fall within the spirit and broad scope of the appended claims.

The method can be applied to other alcohol beverages to use a lower quality ethanol product to produce a higher quality product. Various spirits can be produced including, without limitation, brandy tequila, whisky, vodka, gin, and sake.

The exemplary method uses two distillers. It is possible for the method to be implemented using more than two distillers, with one producing a crude ethanol base, one or more producing an intermediate product, and a final distillery or bottling operation producing a final bottled ethanol beverage product.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

The claims as filed are intended to be as comprehensive as possible, and NO subject matter is intentionally relinquished, dedicated, or abandoned.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. A method for producing a high-grade ethanol beverage by converting a low-grade ethanol feedstock, comprising the steps of:
importing a low-grade ethanol feedstock comprising a crude ethanol distillate containing undesired non-ethanol components;
distilling the low-grade ethanol feedstock into a high-grade ethanol at an importing distillery that substantially removes the undesired non-ethanol components; and
ageing or blending the high-grade ethanol, or a combination of both, to produce a desired ethanol beverage product flavored so as to be consistent with origin.

18. The method of claim 17, further comprising the step of:
producing a majority of waste byproducts from the production of the ethanol beverage product during production of the crude ethanol distillate for local disposal.

19. The method of claim 17, further comprising the step of:
extracting a sugarcane product suitable for fermenting into a ethanol containing beer; and
distilling the beer into the low-grade ethanol feedstock.

20. The method of claim 17, further comprising the step of:
distilling the low-grade ethanol distillate with a single step distillation method.

21. The method of claim 17, further comprising the step of:
distilling the low-grade ethanol distillate with a two-step distillation method.

22. The method of claim 17, further comprising the step of:
distilling the high-grade ethanol with a multi-step distillation method.

23. The method of claim 17, wherein the undesired non-ethanol components comprise aldehydes, organic acids, esters, and fusel oils.

24. A method for producing a high-grade ethanol beverage, comprising the steps of:
extracting an ethanol source for fermenting into a beer for distillation;
distilling the beer into a low-grade ethanol feedstock distillate for export to a distillery for refinement into a high-grade ethanol that substantially removes undesired non-ethanol components;
wherein extracting, fermenting, and distilling the beer substantially reduces production of waste byproducts at said distillery.

25. The method of claim 24, further comprising the step of:
disposing the waste byproducts using at least one of the following methods:
a) ocean or other water discharge;
b) pre-treating of the waste before performing a);
c) spraying on dusty unpaved roads to reduce dust;
d) cattle feed;
e) feed supplements;
f) farming;
g) land farming;
h) irrigation;
i) fuel; or
j) fuel additive.

26. The method of claim 24, further comprising the step of:
distilling the low-grade ethanol distillate with a single step distillation method.

27. The method of claim 24, further comprising the step of:
distilling the low-grade ethanol distillate with a two-step distillation method.

28. The method of claim 24, further comprising the step of:
distilling the high-grade ethanol with a multi-step distillation method.

29. The method of claim 24, wherein the ethanol source comprises:
sugarcane juice;
molasses;
cane syrup; or
other sugar cane by-products.

30. (canceled)

31. The method of claim 24, wherein the undesired non-ethanol components comprise aldehydes, organic acids, esters, and fusel oils.

32. (canceled)

33. (canceled)

34. (canceled)

35. (canceled)

36. (canceled)

37. A method for distilling a higher-quality ethanol beverage using a low-quality intermediate ethanol feedstock, comprising the steps of:
distilling a shipped low-quality ethanol feedstock, wherein the low-quality ethanol feedstock contains undesired non-ethanol components, into a high-quality ethanol at an importing distillery that substantially removes the undesired non-ethanol components; and
bottling a desired higher-quality ethanol beverage product aged, flavored, and labeled so as to be consistent with origin, type, and brand of beverage product.

38. (canceled)

47. The method of claim 37, wherein the undesired non-ethanol components comprise aldehydes, organic acids, esters, and fusel oils.

38. (canceled)

39. The method of claim 37, further comprising the step of:
distilling the high-quality ethanol with a multi-step distillation method.

40. The method of claim 37, further comprising the step of:
distilling the high-quality ethanol using a two to four column distillation system.

41. (canceled)

42. (canceled)

43. (canceled)

44. (canceled)

45. The method of claim 37, further comprising the step of:
producing a substantial portion of total waste byproducts produced by the production of the low-quality ethanol feedstock; and
disposing of the waste byproducts near the site of production of the low-quality ethanol feedstock.

46. The method of claim 37, further comprising the step of:
disposing waste byproducts using at least one of the following methods:
pre-treating of the waste before performing water discharge;
spraying on dusty unpaved roads to reduce dust;
cattle feed;
feed supplements;
farming;
land farming;
irrigation;
fuel; or
fuel additive.
